(19) United States
(12) Patent Application Publication
(10) Pub. No.: US 2008/0149808 A1
(43) Pub. Date: Jun. 26, 2008

(54) METHOD AND APPARATUS FOR PRODUCING CONCRETE STRUCTURES

(75) Inventors: William Raymond MALONE, Vancouver (CA); Chris Michael KINCH, Santiago (CL); Kenneth Oscar OLSEN, Santiago (CL); Herman Pablo ROSEN SAGREDO, Santiago (CL)

Correspondence Address: BENNETT JONES;C/O MS ROSEANN CALDWELL, 4500 BANKERS HALL EAST, 855 - 2ND STREET, SW, CALGARY, AB, T2P 4K7, omitted

(73) Assignee: CANADIAN ROCKPORT HOMES LTD., Vancouver (CA)

(21) Appl. No.: 11/613,756

(22) Filed: Dec. 20, 2006

(51) Int. Cl. B28B 7/08; E04B 1/16

(52) U.S. Cl. 249/137; 52/742.14

(57) ABSTRACT

A building structure formed of concrete and including dams to form raised structures on the roof and a method of overturning the concrete mold.

### FIELD OF THE INVENTION

The present invention relates to methods and apparatus for prefabricating concrete structures, and more particularly to methods and apparatus for prefabricating concrete pitched roof modules.

### BACKGROUND OF THE INVENTION

Concrete building modules may be used to construct durable and affordable buildings. Concrete building modules are generally formed on formwork. Reinforcing in the form of mesh is generally first applied around the formwork and then concrete is applied as by pouring or spraying. Spraying or “shotcreting” of concrete applies thin layers of concrete and is advantageously used to apply concrete to non-horizontal surfaces. When concrete is applied to a smooth surface it produces a smooth dense concrete surface that needs minimal cosmetic treatment.

Concrete building modules are often box shaped and are roofed with standard frame structure or with a flat concrete slab. However, there is sometimes a desire to construct a building's outer structural envelope entirely of concrete, but with a peaked roof.

### SUMMARY OF THE INVENTION

In accordance with a broad aspect of the present invention, there is provided a mold form for producing a concrete roof structure comprising: a first substantially planar surface including a first outer edge, a second substantially planar surface including an outer edge and a connected edge, the connected edge being connected to the first substantially planar surface in a position so as to form a V-shape between the two surfaces; and elongated concrete dam sections supported above and spaced in relation to the two substantially planar surfaces and spaced from the two outer edges.

In accordance with another broad aspect of the present invention, there is provided a mold form comprising: a first substantially planar surface with a first outer edge, a second substantially planar surface including an outer edge and a connected edge, the connected edge being connected at an intersection to the first substantially planar surface in a position so as to form a V-shape between the two surfaces; and a substantially semi cylindrical section connected to the mold form to permit the mold form to be rotated therewith between a concrete accepting position, with the intersection of the V-shape positioned downward and a molded roof structure release position wherein the intersection of the V-shape is inverted to point upwards.

In accordance with another broad aspect of the present invention, there is provided a method for producing a concrete roof structure comprising: providing a mold form including a first substantially planar surface with a first outer edge, a second substantially planar surface including an outer edge and a connected edge, the connected edge being connected at an intersection to the first substantially planar surface in a position so as to form a V-shape between the two surfaces; and a support structure for the mold surfaces, the support structure including a substantially semi cylindrical section to permit the mold form to rotate between a concrete accepting position and a molded roof structure release position; applying concrete to the first and second planar surfaces; allowing the concrete to set to create a concrete structure; and inverting the form by rotating the form using the substantially semi cylindrical section as a rotation supporting member to position the concrete structure form in the molded roof structure release position.

It is to be understood that other aspects of the present invention will become readily apparent to those skilled in the art from the following detailed description, wherein various embodiments of the invention are shown and described by way of illustration. As will be realized, the invention is useful for other and different embodiments and its several details are capable of modification in various other respects, all without departing from the spirit and scope of the present invention. Accordingly the drawings and detailed description are to be regarded as illustrative in nature and not as restrictive.

### BRIEF DESCRIPTION OF THE DRAWINGS

Referring to the drawings wherein like reference numerals indicate similar parts throughout the several views, several aspects of the present invention are illustrated by way of example, and not by way of limitation, in detail in the figures, wherein:

FIG. 1 shows in schematic, sectional form a house being constructed using a roof module in accordance with one aspect of the present invention;

FIG. 2 is a perspective view of a mold form in accordance with one aspect of the present invention;

FIG. 3a to 3f show schematic views of various other mold forms in accordance with another aspect of the present invention. FIGS. 3a, 3b, 3c and 3d are sectional views through a mold form in a concrete-accepting position prior to application of concrete (see I-I of FIG. 3e for an approximate sectional reference). FIG. 3e is a top plan view of a mold form in a concrete-accepting position prior to application of concrete and FIG. 3f is a perspective view of a mold form in a concrete-accepting position prior to application of concrete.

FIGS. 4a to 4c show a monolithic roof module produced using a mold form as shown in FIGS. 3a through 3f. FIG. 4a is a sectional view orthogonal to the length of the roof peak (see II-II of FIG. 4c ), FIG. 4b is a top perspective view and FIG. 4c is a top plan view;

FIG. 5a shows a side elevation of one embodiment of a rib joist useful in the present invention and FIG. 5b is a sectional view along line III-III of FIG. 5a;

FIGS. 6a to 6h schematically show a method for rotating a mold form from a concrete accepting position to a molded roof structure release position and back again; and

FIGS. 7a and 7b are schematic end elevations of one embodiment of a mold form according to the present invention.

### DETAILED DESCRIPTION OF VARIOUS EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

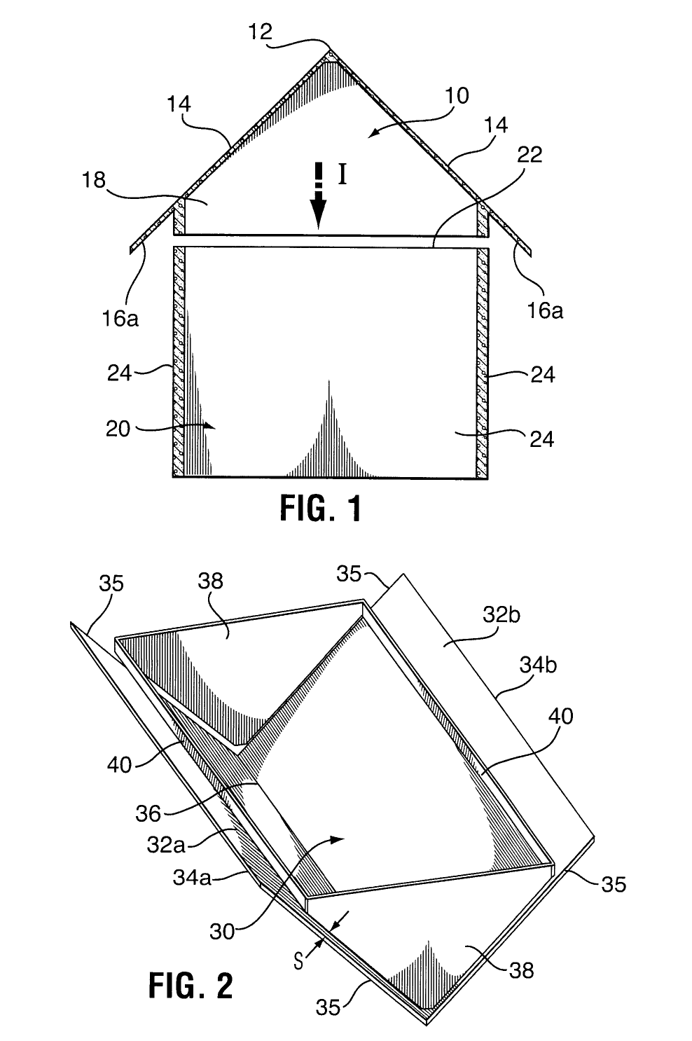

Referring to FIG. 1, using methods and forms such as those described herein, a roof structure 10 may be produced from concrete and may have at least one peak 12 between at least two sloping roof surfaces 14. The roof may be a simple gable form roof as shown with two sloping roof surfaces 14, one peak 12 formed at the intersection between the sloped surfaces, eaves 16a at the outer edges of the surfaces opposite the intersection and with, as shown, or without gable walls 18 at either end (only one of which can be seen). Alternately, other roof forms such as a hipped roof, a gable hipped roof, etc. may be produced, as desired.

Once formed, roof structure 10 may be installed, arrow I, on a base building structure 20, for example on the upper edges 22 of a plurality of its walls 24.

A form for producing a concrete roof structure may take various forms, for example, depending on the construction of the form itself and on the shape and construction of the roof structure that is desired. With respect to the construction of the mold, for example, it can be formed as a solid structure with molding surfaces defined therein. Alternately, a mold can include molding surfaces formed out of sheet materials connected together and/or formed to define the molding surfaces in various ways, for example, sheet materials may be supported by a fabricated steel support structure to define the molding surfaces. With respect to the molding surfaces, for example, the form may include a number of substantially planar surfaces arranged at various angles to connect at at least one intersection to form an overall surface that includes at least one V-shaped section therethrough.

A simple mold form 30 is shown in FIG. 2 that is formed of plate materials and includes an inner surface selected to accept, support and mold an application of concrete. The inner surface includes a first substantially planar surface 32a and a second substantially planar surface 32b. Each of the surfaces include an outer edge 34a, 34b. Surfaces 32a, 32b come together at an acute angle and are connected at an elongated intersection 36 to form an overall V-shaped space between the planar surfaces.

The mold of FIG. 2 may define the shape of a simple gable-form roof with two sloping roof surfaces defined through surfaces 32a, 32b, one roof peak formed at intersection 36 between the surfaces and a roof edge or eaves at the edges 34a, 34b of surfaces 32a, 32b, for example, opposite the intersection.

Further substantially planar surfaces can be included in the mold, for example, a substantially triangular planar surface 38 that spans between surfaces 32a, 32b. Such surfaces 38 may, for example, be used to support concrete in order to define gable walls at either end of the sloping roof surfaces. Such surfaces 38 may be placed at end edges 35 of surfaces 32a, 32b, as shown, or they may be spaced inward from the end edges 35 of surfaces 32a and 32b in order to form eaves that extend beyond the gable walls.

Mold 30 with an inner surface selected to act as the molding surface creates a final concrete pitched roof module with a smooth outer surface and a rougher inner roof surface. In such a module, little external roof finishing is required. For example, the exterior surface may simply be painted. Pigments may also be mixed right into the concrete eliminating even the need for painting. The substantially planar surfaces 32a and 32b may also be stamped with a relief pattern such that the external surface of the resulting concrete roof structure resembles slate tiles, clay tiles, etc. If further finishing is desired, of course, the roof module may be sheathed with roof shingles, tiles, roofing panels, etc. Any eaves may be left unfinished, or simply painted, or may be boxed in or have fascia or soffits attached thereto, as desired.

The form may further include spaces, forms or devices on or in the mold to accept, to form or to retain reinforcing members in position in the mold. For example, in one embodiment, reinforcements in the form of rib joists 250 are formed separately and placed in the mold. Such reinforcements may be formed of materials such as steel, concrete, structural polymers, etc. and formed as wire, mesh, beams, cables, rods, etc. In another embodiment, the reinforcements may be formed by building up thicker portions of the concrete structure.

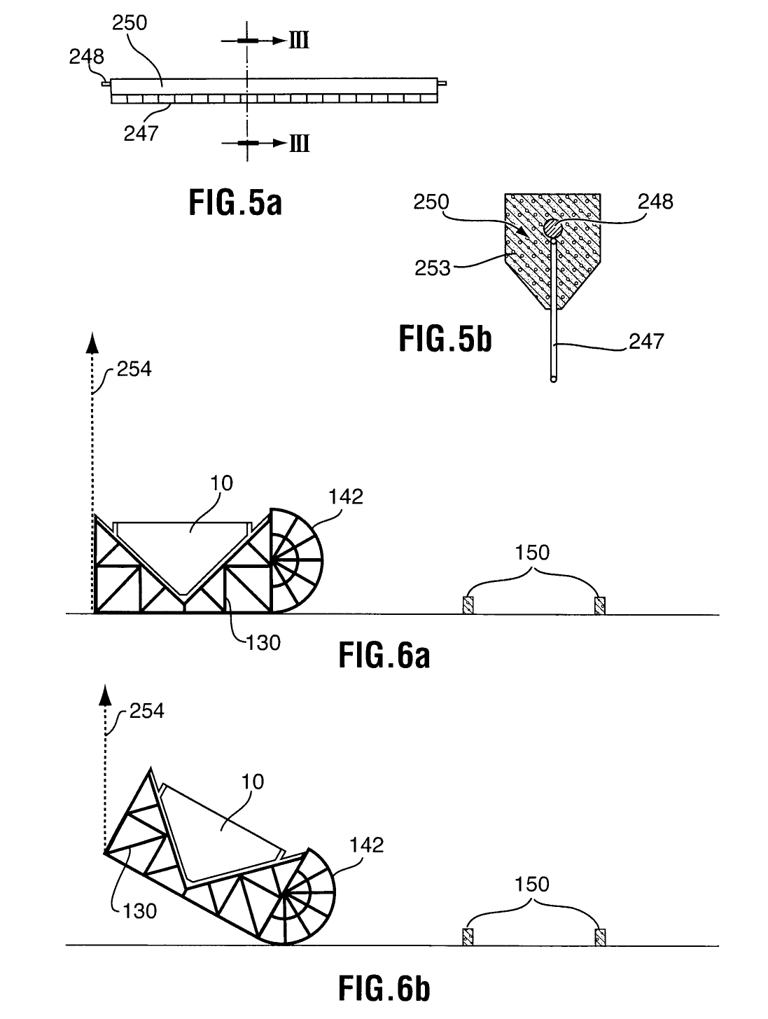

For example with reference to FIGS. 5a and 5b, a rib joist 250 may include reinforcements for example one or more rebar 248 extending along at least portions of its length and/or mesh 247 cast in a concrete body 253. The illustrated rib joist 250 may be set in the mold with the mesh extending below body 253 and then the concrete may be filled in thereabout.

In the illustrated embodiment of FIG. 2, space is provided such that reinforcements may be positioned in the mold for example along intersection 36 and/or at various positions along surfaces 32a, 32b. In addition, mold 30 includes one or more dam sections 40 extending adjacent to but spaced in relation to surfaces 32a, 32b in a position to retain or form beam walls along the planar surface. In the illustrated embodiment, for example, two dam sections 40 are provided each being used to form a concrete beam wall. In addition, reinforced concrete rib joists 250 may be placed at regular intervals along the planar surfaces 32a and 32b, which in turn become integral to the concrete roof structure during the placement of the concrete. Further, reinforcing steel may be placed along the intersection 36. When the concrete is filled into this intersection region, it forms a ridge beam.

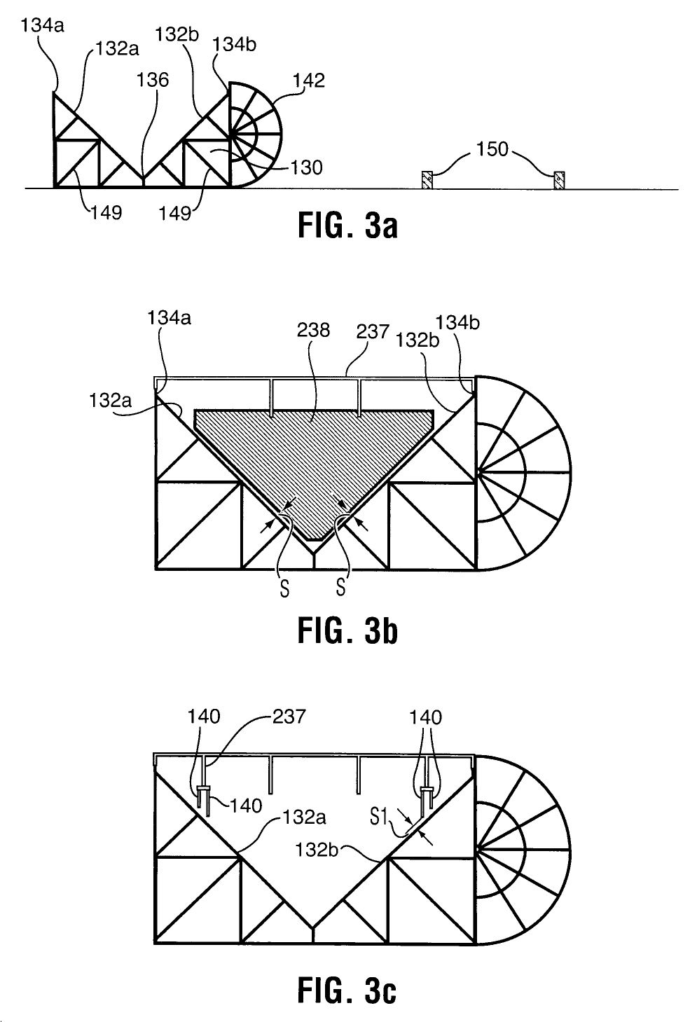

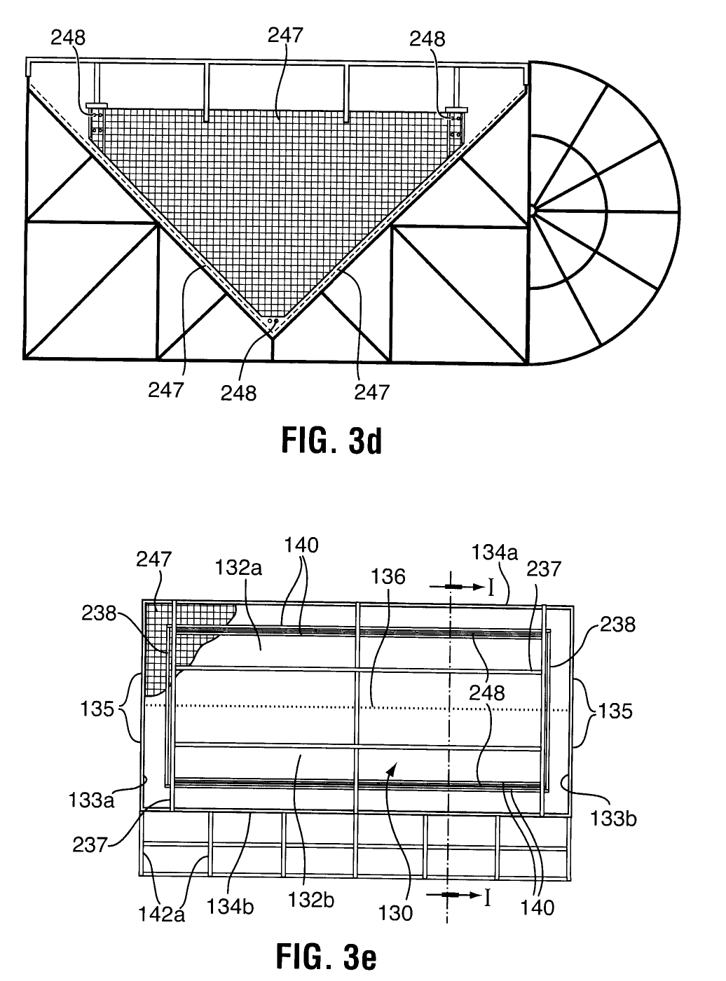

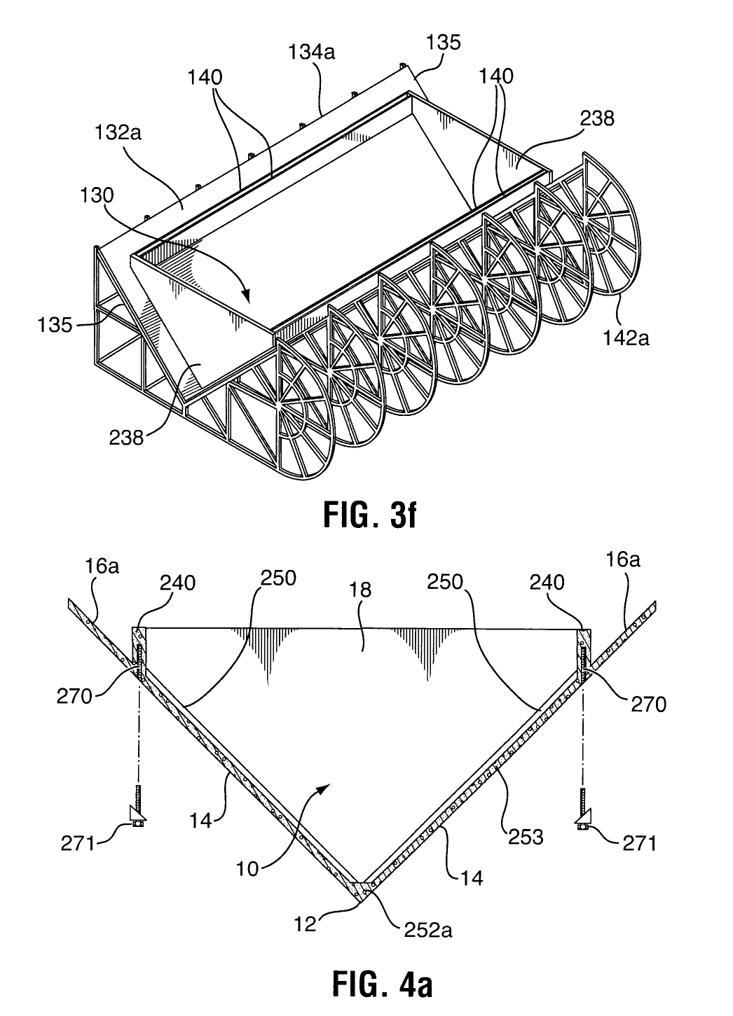

Referring to FIGS. 3a through 3f, a mold form 130 is shown. Mold form 130 is formed of plate materials and includes an inner surface selected to accept, support and mold an application of concrete. The inner surface includes a first substantially planar surface 132a and a second substantially planar surface 132b. Each of the surfaces includes an outer edge lip 134a, 134b and end lips 133a, 133b to define a depth of the concrete applied to the surfaces 132a and 132b. Surfaces 132a, 132b come together at an acute angle and are connected along an elongate intersection 136 to form an overall V-shaped space between the planar surfaces.

In the illustrated embodiment of FIG. 3b, 3d, 3e, and 3f, the mold form includes at least one substantially triangular planar plate 238 that spans between the two surfaces 132a, 132b. Such a plate 238 may, for example, define gable walls at either end of the sloping roof surfaces. Such a plate 238 may be placed inward from the end edges 135 of surfaces 132a and 132b in order to form eaves 16b that extend beyond the gable walls 18. When plate 238 is positioned, as shown, away from an edge of the mold surfaces 132a, 132b, plate 238 may be positioned in for the most part in space relation from the surface over which it is placed so that concrete can be applied in the space S therebetween to avoid the creation of a void in the concrete at that location. Thus, the distance between the gable wall forming plate and the surface above which it is mounted, Space S, should be at least that of the desired thickness of the concrete roof module at that location.

In the embodiments of FIGS. 3c, 3d, 3e, and 3f, mold form 130 also includes two pair of concrete dams 140 that operate to form a beam wall 240 on each side of the roof module to be formed. The concrete dams are elongate members extending adjacent to, but in spaced relation from, surfaces 132a and 132b. The space S1 between a surface and a dam permits the application of concrete therebetween. Again, the distance between the dam and the surface above which it is mounted should be at least that of the desired thickness of the concrete roof module at that location.

Dams 140 and plates 238 may be supported in the mold in various ways. For example, the dams and plates may be connected to portions of the mold by means of a support frame 237 as illustrated. In some cases, dams 140 and plates 238 may have to be removed from their position in the mold in order to permit the release of the concrete module from the mold. The dams and the triangular plate sections may be mounted in a releasable manner through various means such as brackets, clamps, bolts, etc. directly to various parts of the mold. Alternatively, for example, dams 140 and plates 238 may be suspended over the main V-form surface on legs supported on the ground adjacent the mold. The dams and the plates may be connected to facilitate handling such that the entire dams/V-plates structure may be lifted away as a single unit after the concrete has set and before the module is to be released from the mold.

Beam walls 240 formed by the dams 140 can be of varying height and thickness according to a specific architectural design. Significant reinforcing steel 248 may be positioned in the mold to be integrated in the beams walls such that they are able to provide the main structural stiffness of the completed roof structure. A ridge beam 252a may be formed along intersection 136 simply using gravity. Again, separately formed reinforcing members such as rebar, I-beams etc. may be placed in the mold so that the ridge beam also contains an amount of reinforcement for structural stiffness. Reinforcing members in the form of rib joists 250, may be formed separately and placed in the mold. Such reinforcements may be formed of materials such as steel, concrete, structural polymers, etc. and formed as wire, mesh, beams, cables, rods, etc.

In the illustrated embodiment, mold form 130 includes plates that form surfaces 132a, 132b and a support structure 149 formed as a framework of steel members. Mold form 130 such as that shown with an inner surface selected to act as the molding surface may be positioned during molding with its V-shape pointing down such that any concrete can be applied from above and will be retained inside the mold. However, after the concrete has set, it will be appreciated that the final form must be inverted for use. As such, in one embodiment such as that illustrated, mold form 130, and in particular support structure 149 includes a substantially fully or semi cylindrical section 142 solidly attached to or formed as part of the support structure 149 for the mold surfaces so that the mold can be rotated in a controlled manner using semi cylindrical section 142 as a rotating member such as a wheel between an upright concrete-accepting position and an inverted molded roof structure release position. Section 142 may be formed in various ways such as by a solid body or, as shown, though a framework including a plurality of substantially circular or semicircular steel members 142a in side by side relation all similarly formed to define a semi cylindrical outer surface that together form the section 142.

In such an embodiment, the apparatus may include releasable retainers such as clamping bolts 271 that include heads positionable on the exterior (non-molding) side of mold form and are screwed into threaded receptacles 270 positioned within the molding area, for example positioned to be embedded in the concrete of the molded form. Of course, other devices may be used to retain the concrete module in the mold as the mold form is inverted.

The mold may be released onto a ground-level surface adjacent the mold form. In the illustrated embodiment, unloading support blocks 150 are positioned to accept the roof structure. Unloading support blocks 150 may take various forms depending on the nature of operations in the manufacturing site. For example, unloading support blocks 150 may be a solid surface on which the concrete roof structure is to be placed or stored after removal from the mold. Unloading support blocks 150 may also or alternately be part of a loading area where trucks, train cars, trailers, etc. are brought to accept the concrete roof module from the mold.

Semi cylindrical section 142 and support structure 149 should be formed to withstand the static and dynamic stresses of operation.

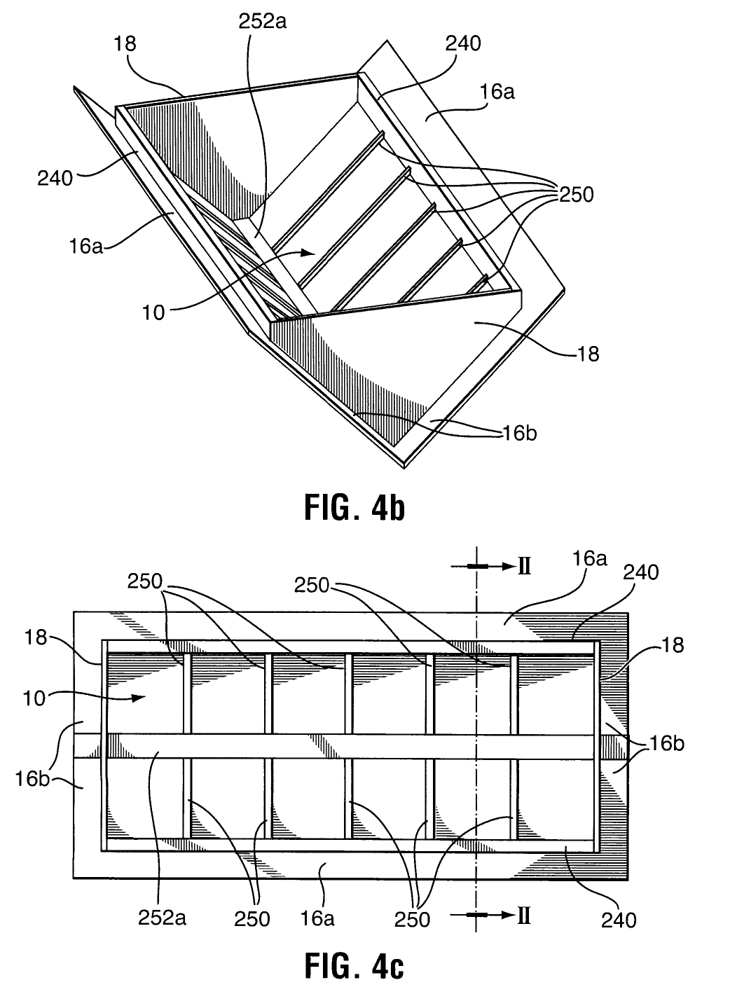

A method for producing a concrete roof module is described with reference to FIGS. 3a to 3f and 4a to 4c. The method includes providing a mold form 130 and positioning it in a concrete accepting position, which in the illustrated embodiment includes positioning the form with the V-shape formed by its surfaces 132a, 132b pointing down so that the opening between the surfaces is positioned to open upwardly. If desired, a release agent may be applied to any surfaces of the mold form to which concrete is intended to be applied. Such surfaces may include for example planar surfaces 132a, 132b, gable wall surfaces 238, contact surfaces of dam sections 140, etc.

Separate reinforcements, if any, may then be positioned in the mold. In the illustrated embodiment, separate reinforcements include, for example, a reinforcing grid of steel mesh 247 positioned near the mold form surfaces, reinforcing steel rods 248 positioned substantially along the length of intersection 236, reinforcing steel rods 248 positioned substantially along the length of, and in between pairs of concrete dams 140, and a plurality of rib joists 250 extending substantially perpendicularly from the intersection.

Thereafter concrete may be applied to mold form 130. Concrete 253 may be applied in various ways (spraying, pouring, etc.) and all at once or in stages, as desired. For example, concrete may be poured into thicker regions and/or about the heavily reinforced portions of the mold and vibration may be used to urge the concrete to infiltrate the reinforcements. This may be useful, for example, along intersection 36 where ridge beam 252 is formed. Concrete 253 may then be applied, as by spraying or pouring, onto the remainder of the mold.

At some stage during concrete application, concrete may be applied into or behind dams 140 to create thickened areas defining beam walls 240.

Thereafter, time may be allowed for the concrete to set and the set module may be then be released from mold form 130 along with any reinforcements embedded therein. The setting of the concrete may be accelerated by means of steam curing.

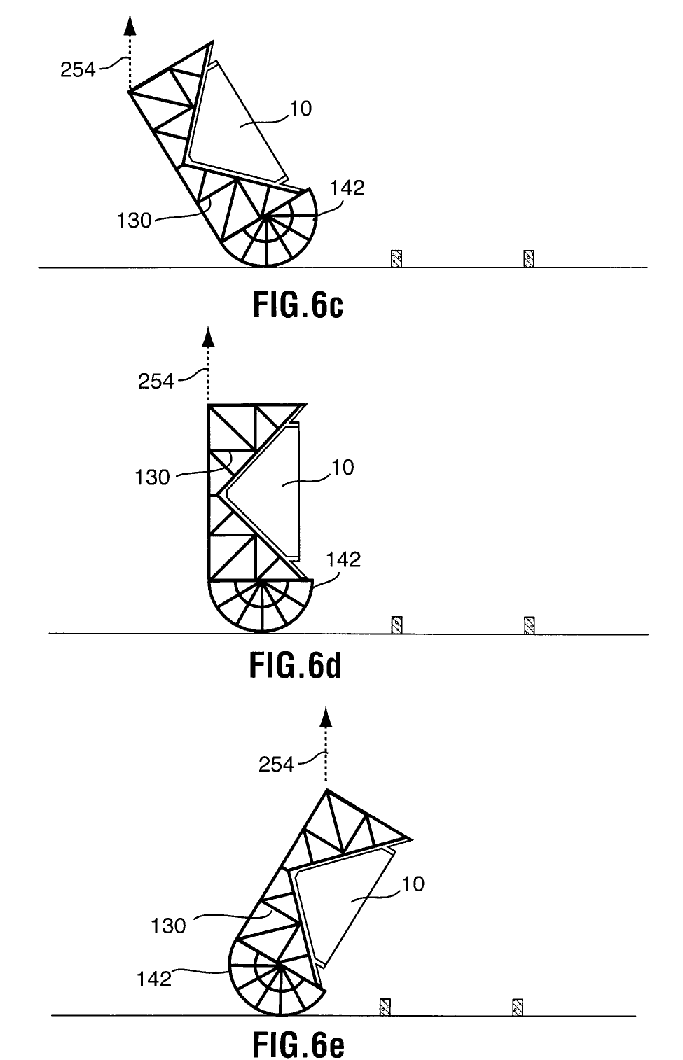

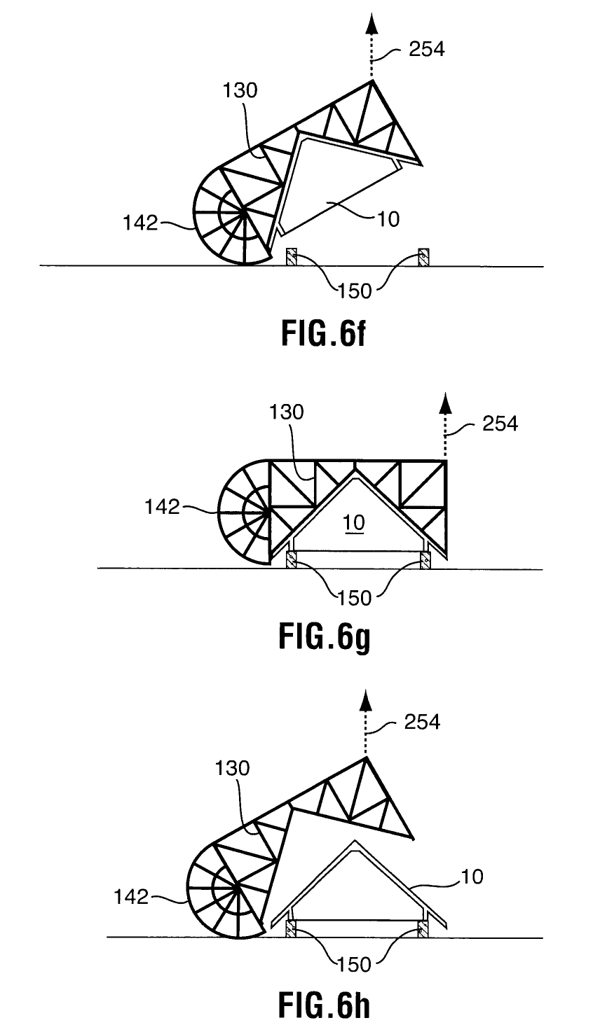

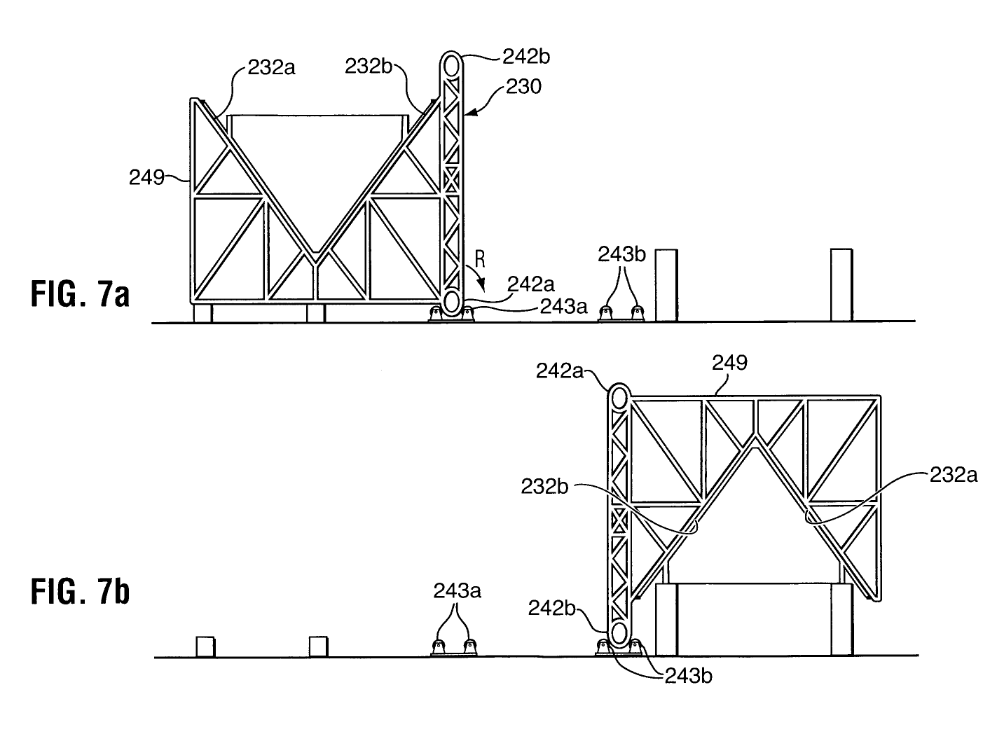

The step of releasing the concrete roof structure from the mold form may include rotation as shown in FIGS. 6a through 6h using substantially semi cylindrical section 142 as a wheel. In this process, the mold form and concrete roof structure are together rotated in a controlled fashion from the concrete accepting position to the molded roof structure release position. Once at rest on the unloading support blocks 150, the concrete roof structure is then released from the mold form. The rotation is then reversed and the mold form only is returned in a controlled fashion back to the concrete accepting position. Rotation of the mold may be accomplished, for example, by lifting an edge of the mold form opposite substantially semi cylindrical section 142 with lifting cables 254 driven by an overhead crane, winch, etc. Section 142 may be unsecured as shown to simply roll over the ground surface. Alternately, section 142 or another semi cylindrical form may be positioned to act in a bearing on the ground surface such that the mold rotates without movement over the ground surface. Alternately, as described hereinbelow with respect to FIG. 7, herein below, one or more semi cylindrical members may be provided to permit the form to be rotated. As another alternative, section 142, perhaps in a smaller form, may be secured to an axle (not shown) and a secured support therefor such that the combination of the semi cylindrical structure and the axle acts as a hinge about which the mold may be rotated for inversion.

Once inverted, any retaining clamping bolts 271 may be released and the molded roof structure 10 may be released from the mold. To release the module from the mold, any retainers holding the module in the mold may have to be removed and the mold form may be rotated back to lift away from the concrete roof module in preparation for forming a next concrete roof structure.

FIG. 6a shows a mold form in a concrete accepting position after application of concrete and removal of the substantially triangular plates and the dams with a lifting cable connected thereto in preparation for rolling the mold form. At this point the V-shape between surfaces 32a, 32b points downwardly. FIGS. 6b to 6f show transitional stages of the mold form being lifted by cable 254 to roll on section 142 from the concrete accepting position to the molded roof structure release position. During this process the molded roof structure 10 remains secured in the form. FIG. 6g shows the mold form in the molded roof structure release position and FIG. 6h shows monolithic molded roof structure 10 released from the form and resting on supports 150 with the V-shape between surfaces 32a, 32b pointing upwardly, while the form is being moved back from the molded roof structure release position to the concrete accepting position. The rolling procedure allows the molded roof structure to be released in a configuration wherein it can be transported and used without again having to be rotated about its long axis, which is the axis parallel to the length of the roof peak.

With reference to FIGS. 7a and 7b, another mold form 230 may include plates that form surfaces 232a, 232b and a support structure 249 formed as a framework of steel members. Mold form 230 such as that shown with an inner surface selected to act as the molding surface may be positioned during molding with its V-shape pointing down such that any concrete can be applied from above and will be retained inside the mold. However, after the concrete has set, it will be appreciated that the final form must be inverted for use. As such, in one embodiment such as that illustrated, support structure 249 of the mold form includes a pair of substantially semi cylindrical sections 242a, 242b solidly attached thereto or formed thereon. Semi cylindrical sections 242a, 242b allow the mold to be rotated wherein the semi cylindrical sections are used as wheels that support rolling, arrow R, the mold between an upright concrete-accepting position (FIG. 7a ) and an inverted molded roof structure release position (FIG. 7b ). In one embodiment, as shown, bearings 243a, 243b may be positioned to support and facilitate the rotation of the mold form. In particular, bearings 243a, 243b are positioned to accept sections 242a, 242b, respectively, as the mold is rotated. The bearings reduce the length of travel during rotation by accommodating rotation without travel.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope as defined in the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims. No claim element is to be construed under the provisions of 35 USC 112, sixth paragraph, unless the element is expressly recited using the phrase “means for” or “step for”.

I claim:

1. A mold form for producing a concrete roof structure comprising: a first substantially planar surface including a first outer edge, a second substantially planar surface including an outer edge and a connected edge, the connected edge being connected to the first substantially planar surface in a position so as to form a V-shape between the two surfaces; and elongated concrete dam sections supported above and spaced in relation to the two substantially planar surfaces and spaced from the two outer edges.

2. The mold form of claim 1 further comprising: a substantially triangular planar section positioned above and fitting within the V-shape of the two substantially planar surfaces.

3. A mold form comprising: a first substantially planar surface with a first outer edge, a second substantially planar surface including an outer edge and a connected edge, the connected edge being connected at an intersection to the first substantially planar surface in a position so as to form a V-shape between the two surfaces; and a substantially semi cylindrical section connected to the mold form to permit the mold form to be rotated therewith between a concrete accepting position, with the intersection of the V-shape positioned downward and a molded roof structure release position wherein the intersection of the V-shape is inverted to point upwards.

4. The mold form of claim 3 further comprising: an elongated concrete dam section supported above and spaced in relation to the first substantially planar surface.

5. A method for producing a concrete roof structure comprising: providing a mold form including a first substantially planar surface with a first outer edge, a second substantially planar surface including an outer edge and a connected edge, the connected edge being connected at an intersection to the first substantially planar surface in a position so as to form a V-shape between the two surfaces; and a support structure for the mold surfaces, the support structure including a substantially semi cylindrical section to permit the mold form to rotate between a concrete accepting position and a molded roof structure release position; applying concrete to the first and second planar surfaces; allowing the concrete to set to create a concrete structure; and inverting the form by rotating the form using the substantially semi cylindrical section as a rotation supporting member to position the concrete structure form in the molded roof structure release position.
